(19) United States
(12) Patent Application Publication
(10) Pub. No.: US 2020/0366805 A1
(43) Pub. Date: Nov. 19, 2020

(54) SYSTEM AND NON-TRANSITORY COMPUTER READABLE MEDIUM

(71) Applicant: FUJI XEROX CO., LTD., Tokyo (JP)

(72) Inventor: Teppei AOKI, Kanagawa (JP)

(73) Assignee: FUJI XEROX CO., LTD., Tokyo (JP)

(21) Appl. No.: 16/575,900

(22) Filed: Sep. 19, 2019

(30) Foreign Application Priority Data
May 17, 2019 (JP) 2019-093638

(51) Int. Cl. H04N 1/00

(52) U.S. Cl. CPC H04N 1/00973; H04N 1/00244; H04N 2201/0074; H04N 1/00888; H04N 2201/0039; H04N 1/00326

(57) ABSTRACT

A system includes a detection device, a processing device, and an external device. The detection device includes a detector that detects a nearby event and a first controller that transmits data related to an event detected by the detector to the external device. The processing device includes a processor that performs processing or a second controller that controls the detection device. The external device includes a generation unit that receives and analyzes the data transmitted from the first controller, and generates control information for controlling the processor or the detection device, and a transmitter that transmits the control information to the second controller associated with the first controller from which the data is transmitted.

### CROSS-REFERENCE TO RELATED APPLICATIONS

This application is based on and claims priority under 35 USC 119 from Japanese Patent Application No. 2019-093638 filed May 17, 2019.

### BACKGROUND

### (i) Technical Field

The present disclosure relates to a system and a non-transitory computer readable medium.

### (ii) Related Art

For example, in the technology described in Japanese Unexamined Patent Application Publication No. 2018-152642, from among multiple monitoring devices provided with a monitoring camera connected to a communication control device, one monitoring device is set to a parent while the others are set to children, and communication between the parent and the children is performed according to specified low-power wireless communication by an LPWA communication module, while in addition, communication between the parent and a network channel is performed by mobile communication. If a user receives an abnormality signal from a monitoring camera on a terminal via a server, and the server receives, from the user, an acquisition request for image storage data of monitoring cameras in a monitoring region where the abnormality occurred, the server transmits an image storage data acquisition request command to the monitoring devices. The monitoring devices switch the communication with the server to mobile communication by a mobile communication module, and transmit the image storage data to the server without going through the parent.

### SUMMARY

Even when not performing a process involving a processing device, with a configuration that analyzes data sent from a detection device that detects a nearby event, it may be necessary to continually analyze data sent from the detection device, and electric power for performing the analysis may be necessary.

Aspects of non-limiting embodiments of the present disclosure relate to reducing power consumption compared to a configuration in which a processing device must continually analyze data sent from a detection device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a system including a detection device, a processing device, and an external device. The detection device includes a detector that detects a nearby event and a first controller that transmits data related to an event detected by the detector to the external device. The processing device includes a processor that performs processing or a second controller that controls the detection device. The external device includes a generation unit that receives and analyzes the data transmitted from the first controller, and generates control information for controlling the processor or the detection device, and a transmitter that transmits the control information to the second controller associated with the first controller from which the data is transmitted.

### BRIEF DESCRIPTION OF THE DRAWINGS

Exemplary embodiments of the present disclosure will be described in detail based on the following figures, wherein:

FIG. 1 is a diagram illustrating an example of a schematic configuration of a system according to a first exemplary embodiment;

FIG. 2 is a diagram illustrating an example of a schematic configuration of an image processing device according to the first exemplary embodiment;

FIG. 3A is a diagram illustrating an example of a schematic configuration of a first detection device, and FIG. 3B is a diagram illustrating an example of a schematic configuration of a second detection device;

FIG. 4 is a diagram illustrating an example of a schematic configuration of a server device according to the first exemplary embodiment;

FIG. 5 is one example of a flowchart illustrating a control information transmission process performed by the server device;

FIG. 6 is one example of a flowchart illustrating a switch opening-closing control process performed by the image processing device;

FIG. 7 is a diagram illustrating an example of a schematic configuration of a system according to a second exemplary embodiment;

FIG. 8 is a diagram illustrating an example of a schematic configuration of a third detection device;

FIG. 9 is a diagram illustrating an example of a schematic configuration of a robot;

FIG. 10 is a diagram illustrating an example of a schematic configuration of a server device according to the second exemplary embodiment;

FIG. 11 is one example of a sequence diagram illustrating a processing sequence by the system according to the second exemplary embodiment;

FIG. 12 is a diagram illustrating an example of a schematic configuration of a system according to a third exemplary embodiment;

FIG. 13 is a diagram illustrating an example of a schematic configuration of a mobile terminal;

FIG. 14 is a diagram illustrating an example of a schematic configuration of a fourth detection device;

FIG. 15 is a diagram illustrating an example of a schematic configuration of a server device according to the third exemplary embodiment; and

FIG. 16 is one example of a sequence diagram illustrating a processing sequence by the system according to the third exemplary embodiment.

### DETAILED DESCRIPTION

Hereinafter, exemplary embodiments will be described in detail and with reference to the attached drawings.

### First Exemplary Embodiment

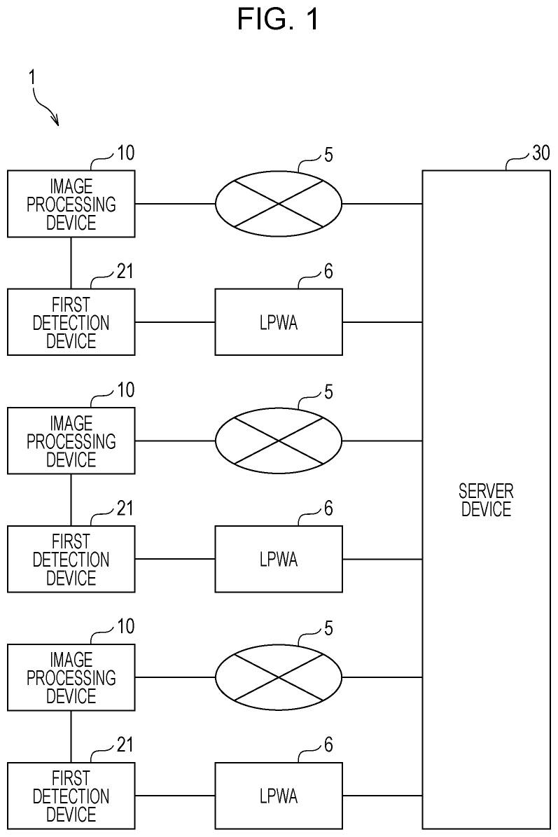

FIG. 1 is a diagram illustrating an example of a schematic configuration of a system 1 according to a first exemplary embodiment.

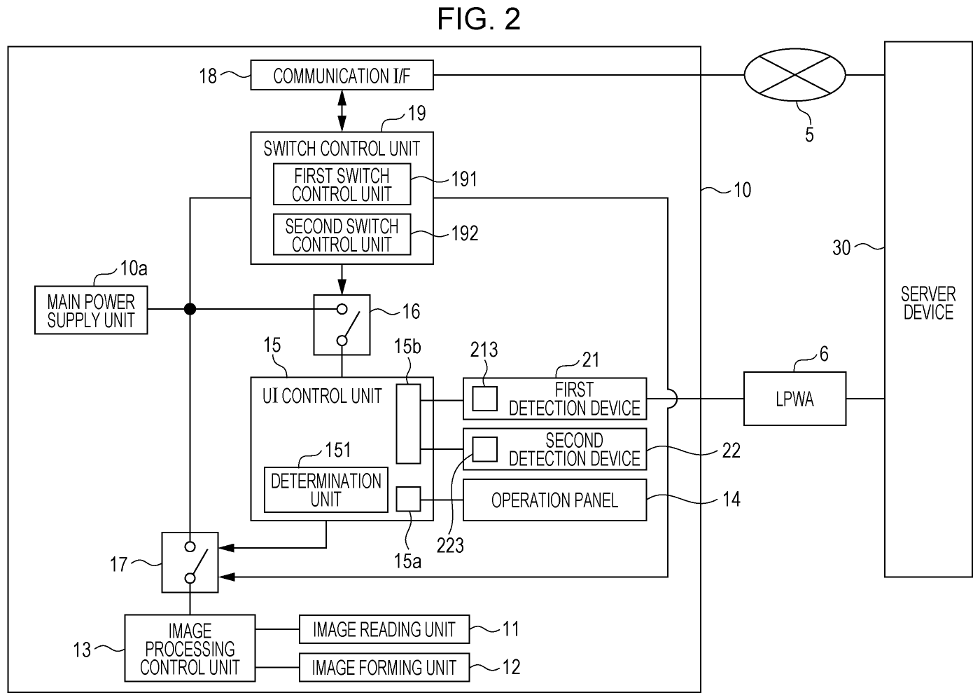

FIG. 2 is a diagram illustrating an example of a schematic configuration of an image processing device 10 according to the first exemplary embodiment.

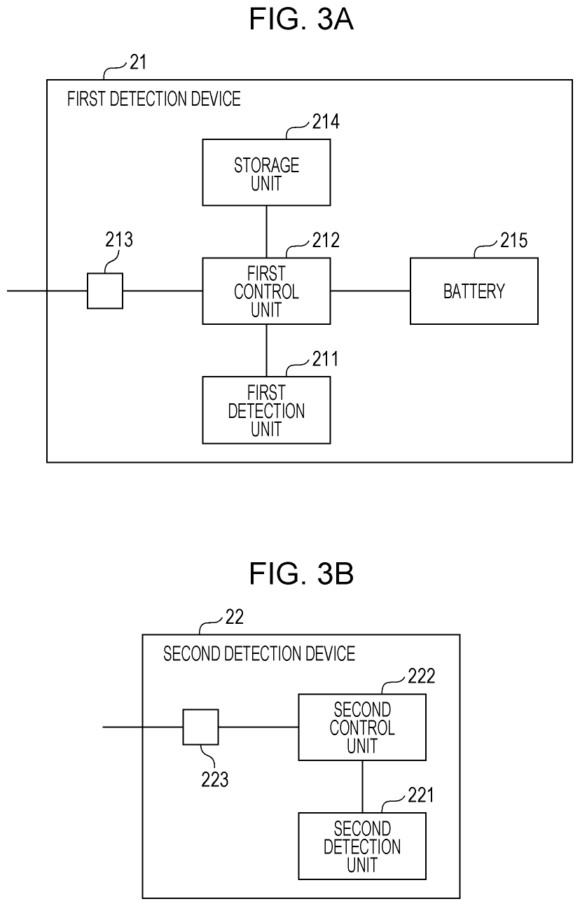

FIG. 3A is a diagram illustrating an example of a schematic configuration of a first detection device 21. FIG. 3B is a diagram illustrating an example of a schematic configuration of a second detection device 22.

The system 1 according to the first exemplary embodiment is provided with image processing devices 10 as one example of a processing device that performs image processing, and first detection devices 21 that detect a nearby event. Also, the system 1 is provided with a server device 30 as one example of an external device that receives and analyzes data transmitted from the first detection devices 21, and transmits control information for controlling the image processing devices 10 to the image processing devices 10. In addition, the system 1 is provided with second detection devices 22 that are connected to the image processing devices 10 and that detect a nearby event.

The image processing devices 10 and the server device 30 are capable of communicating with each other over networks 5. The networks 5 are not particularly limited insofar as the networks 5 are communication networks used for data communication between devices, and may be the Internet, a wide area network (WAN), and a local area network (LAN) for example. The communication channel used for data communication may be wired, wireless, or a combination of the two. Also, it may be configured such that a relay device such as a gateway device or a router is used to connect each device through multiple networks and communication channels. Note that in the case in which a wireless communication channel is used, the server device 30 may also be a virtual server in the cloud.

The first detection devices 21 and the server device 30 are capable of communicating with each other through low-power wide-area (LPWA) networks (hereinafter referred to as “LPWA” in some cases) 6. The LPWAs 6 are capable of long-range data communication and feature low power consumption and low cost compared to protocols such as Wi-Fi and Bluetooth (registered trademark), for example. Accordingly, the LPWAs 6 are networks suited to communication with IoT devices. The communication standard used to achieve the LPWAs 6 may be Narrowband IoT (NB-IoT) for example.

### [Configuration of Image Processing Devices 10]

Each image processing device 10 includes an image reading unit 11, an image forming unit 12, and an image processing control unit 13 that controls the image reading unit 11 and the image forming unit 12.

Also, each image processing device 10 includes an operation panel 14 and a user interface (hereinafter referred to as “UI” in some cases) control unit 15 that controls the operation panel 14.

Also, each image processing device 10 includes a main power supply unit 10a for receiving a supply of power from an electric utility and supplying the power to the image processing device 10. Also, each image processing device 10 includes a first switch 16 for switching the supply of power to the UI control unit 15 on and off, and a second switch 17 for switching the supply of power to the image processing control unit 13 on and off.

Also, each image processing device 10 includes a communication interface (hereinafter referred to as “I/F” in some cases) 18 and a switch control unit 19 that acts as one example of a second controller that controls the switching on and off of the first switch 16 and the second switch 17 that act as one example of a processor, on the basis of data acquired through the communication I/F 18.

In addition, each image processing device 10 is provided with the second detection device 22 that detects a nearby event.

The image reading unit 11 reads an image recorded onto a recording medium such as paper. The image reading unit 11 is a scanner, for example, and may be a charge-coupled device (CCD) scanner in which light from a light source is radiated onto a document and the reflected light therefrom is focused by a lens and sensed by a CCD, or a contact image sensor (CIS) scanner in which light from LED light sources is successively radiated onto a document and the reflected light therefrom is sensed by a CIS.

The image forming unit 12 forms an image onto a recording medium. The image forming unit 12 is a printer, for example, and may be an electrophotographic system in which an image is formed by causing toner adhering to a photoconductor to be transferred to a recording medium, or an inkjet printer in which an image is formed by jetting ink onto a recording medium.

The image processing control unit 13 includes a central processing unit (CPU) (not illustrated), random access memory (RAM) (not illustrated) used as working memory of the CPU and the like, and read-only memory (ROM) (not illustrated) that stores various programs executed by the CPU and the like. Additionally, by having the CPU load a program stored in the ROM into the RAM and execute the program, the image processing control unit 13 controls the operations of the image reading unit 11, the image forming unit 12, and the like.

The operation panel 14 includes a display (not illustrated) that displays various information and a keyboard (not illustrated) enabling the user to provide operation input. The display may be for example a touch panel including a function of detecting a position indicated with a finger or the like. The keyboard includes a Start button, numerical keys, and the like.

The UI control unit 15 includes a CPU (not illustrated), RAM (not illustrated), and ROM (not illustrated). Also, the UI control unit 15 includes an operation panel I/F 15a for transmitting and receiving data with the operation panel 14, and a detection I/F 15b for transmitting and receiving data with the first detection device 21 and the second detection device 22.

The UI control unit 15 executes each process according to an operation on the operation panel 14. For example, in the case in which a copy instruction is given through the operation panel 14, the second switch 17 is switched on and the image processing control unit 13 is made to perform a copy process.

The communication I/F 18 includes a connector (not illustrated) for connecting a cable corresponding to the network 5 or the like.

The switch control unit 19 includes a CPU (not illustrated), RAM (not illustrated), and ROM (not illustrated). The switch control unit 19, the UI control unit 15, and the image processing control unit 13 are interconnected by an internal bus (not illustrated), and are capable of transmitting and receiving data with each other.

The switch control unit 19 includes a first switch control unit 191 that controls the switching on and off of the first switch 16 and a second switch control unit 192 that controls the switching on and off of the second switch 17, on the basis of data acquired through the communication I/F 18.

In the case in which a control signal for switching on the first switch 16 described later is received from the server device 30 through the communication I/F 18, the first switch control unit 191 switches on the first switch 16 for a predetermined period.

In the case in which a control signal a control signal indicating that data is to be printed out is received from a terminal device such as a desktop PC, a laptop PC, a tablet PC, or a multifunctional mobile phone (also referred to as a “smartphone”) through the communication I/F 18, the second switch control unit 192 switches on the second switch 17 until the image forming unit 12 finishes the printout.

### [Configuration of First Detection Devices 21]

Each first detection device 21 includes a first detection unit 211 that acts as one example of a detector that detects a nearby event, a first control unit 212 that acts as one example of a first controller that transmits data related to an event detected by the first detection unit 211 (hereinafter referred to as a “detection result” in some cases) to the server device 30, a communication I/F 213, a storage unit 214, and a battery 215.

The first detection unit 211 is a pyroelectric sensor that uses the pyroelectric effect to detect infrared rays of a specific wavelength emitted by human beings, and thereby detect that a human being has entered a first predetermined region decided in advance. The first detection unit 211 is provided with a pyroelectric element, a lens, an IC, a printed circuit board, and the like. The first detection unit 211 detects the amount of change in infrared rays that occurs when a human being moves, and outputs the detected amount of change.

The first control unit 212 includes a CPU (not illustrated), RAM (not illustrated), and ROM (not illustrated). The first control unit 212 transmits the detection result from the first detection unit 211 to the server device 30 through the LPWA 6 periodically at a predetermined frequency. The first control unit 212 uses technology called non-IP data delivery (NIDD), which transmits data without the use of the IP protocol, to transmit data to the server device 30 through the LPWA 6. Herein, the communication via the LPWA 6 includes a “control plane (C-plane)” used for control and a “user plane (U-plane)” containing speech data and packet data. The same also applies to the LTE-M1 and NB-IoT communication standards designed for IoT. For example, in the case of ordinary NB-IoT, control signals are placed in the control plane while packet data is placed in the user plane. On the other hand, NIDD is a technology that communicates according to NB-IoT communication by embedding the content to be communicated into the control plane and not using the user plane. In the following, communication including the control plane and the user plane, like ordinary NB-IoT, will be referred to as “IP communication”, whereas communication including the control plane and not using the user plane, like NIDD, will be referred to as “non-IP communication” in some cases. Because non-IP communication does not use the user plane, small amounts of data may be transmitted efficiently compared to IP communication.

The first control unit 212 transmits data including the amount of change in infrared rays detected by the first detection unit 211 and the International Mobile Equipment Identity (hereinafter referred to as the “IMEI” in some cases) of the first detection device 21 to the server device 30 by non-IP communication through the communication I/F 213. Information about the server device 30 is stored in the storage unit 214.

Each first detection device 21 may be a device capable of connecting to one of the image processing devices 10 by a connection such as Universal Serial Bus (hereinafter referred to as “USB” in some cases), for example. Additionally, when the first detection device 21 is connected to the image processing device 10, the first detection device 21 is supplied with power from the image processing device 10 in the case in which power from the main power supply unit 10a is being supplied to the UI control unit 15, and in addition, it becomes possible to transmit and receive data between the first control unit 212 of the first detection device 21 and the UI control unit 15 of the image processing device 10.

On the other hand, in the case in which power is not being supplied from the image processing device 10, the first detection device 21 transmits the detection result from the first detection unit 211 to the server device 30 under power supplied from the battery 215 included in the first detection device 21 itself.

### [Configuration of Second Detection Devices 22]

Each second detection device 22 includes a second detection unit 221, a second control unit 222, and a communication I/F 223.

The second detection unit 221 is an infrared reflective sensor including a light emitter and a light receiver.

The second control unit 222 includes a CPU (not illustrated), RAM (not illustrated), and ROM (not illustrated), and transmits the detection result from the second detection unit 221 to the image processing device 10 through the communication I/F 223.

The second detection device 22 may be a device capable of connecting to one of the image processing devices 10 by a connection such as USB, for example. When the second detection device 22 is connected to the image processing device 10, the second detection device 22 is supplied with power from the image processing device 10 in the case in which power from the main power supply unit 10a is being supplied to the UI control unit 15, and in addition, it becomes possible to transmit and receive data between the second control unit 222 and the UI control unit 15 of the image processing device 10. Additionally, the second control unit 222 transmits the detection result from the second detection unit 221 to the UI control unit 15 periodically at a predetermined frequency.

Herein, the UI control unit 15 is provided with a determination unit 151 that determines whether or not a human being is present in a second predetermined region decided in advance, on the basis of the detection result from the second detection unit 221, that is, a voltage output from the second detection unit 221. The determination unit 151 compares the voltage output from the second detection unit 221 (or a voltage obtained by amplifying the output voltage) to a standard voltage decided in advance, and if the output voltage exceeds the standard voltage, the determination unit 151 determines that a human being is present in the second predetermined region.

Otherwise, in the case in which the output voltage is the standard voltage or less, the determination unit 151 determines that a human being is not present in the second predetermined region.

In the case in which the determination unit 151 determines that a human being is present in the second predetermined region, the UI control unit 15 switches on the second switch 17 and also keeps the first switch 16 switched on.

Note that the second control unit 222 of the second detection device 22 rather than the UI control unit 15 may determine whether or not a human being is present in the second predetermined region, and transmit the result to the UI control unit 15.

### [Configuration of Server Device 30]

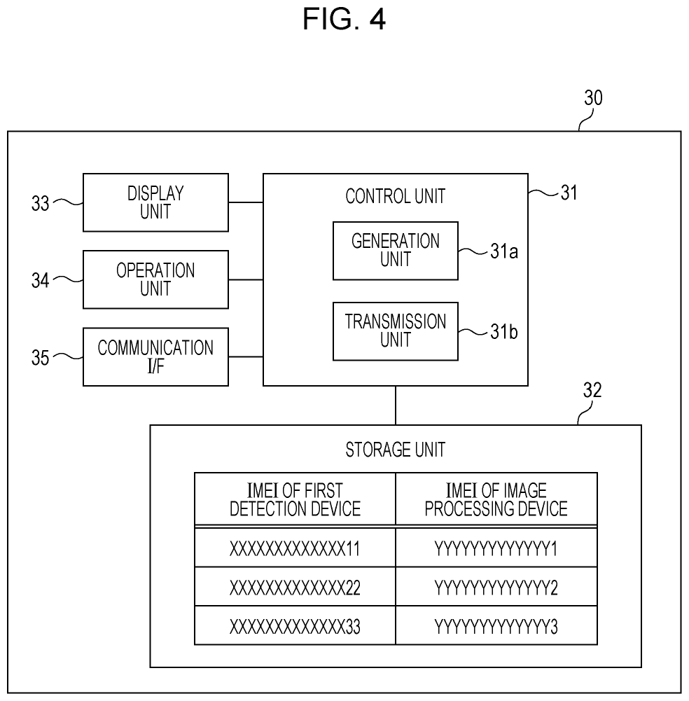

FIG. 4 is a diagram illustrating an example of a schematic configuration of the server device 30 according to the first exemplary embodiment.

As illustrated in FIG. 4, the server device 30 is provided with a control unit 31 that controls the device overall, a storage unit 32 used to store data and the like, a display unit 33 used to display operation reception screens and images, an operation unit 34 that receives input operations from a user, and a communication I/F 35 used to communicate with external devices.

The storage unit 32 may be a storage device such as a hard disk drive (HDD). The storage unit 32 may also be semiconductor memory. The storage unit 32 according to the first exemplary embodiment stores the IMEIs of the first detection devices 21 and the IMEIs of the image processing devices 10 respectively connected to the first detection devices 21 in association with each other.

The display unit 33 is a display device that displays still images, moving images, and the like. The display unit 33 may be a liquid crystal display or an organic electroluminescence (EL) display, for example.

The operation unit 34 is an input device that receives operations from the user. The operation unit 34 may be one or more buttons and switches, a touch panel, and the like.

The control unit 31 includes a CPU (not illustrated), RAM (not illustrated) used as working memory of the CPU and the like, and ROM (not illustrated) that stores various programs executed by the CPU and the like. Additionally, the control unit 31 controls the operations of the server device 30 overall by having the CPU load a program stored in the ROM into the RAM and execute the program.

The control unit 31 of the server device 30 according to the first exemplary embodiment includes a generation unit 31a that acts as one example of a generation unit that receives the detection result transmitted from the first control unit 212 of the first detection devices 21, analyzes the detection results, and generates control information for controlling the image processing devices 10 or the detection devices. Also, the control unit 31 includes a transmission unit 31b that acts as one example of a transmitter that transmits the control information generated by the generation unit 31a to the image processing devices 10.

The generation unit 31a analyzes whether or not the amount of change in infrared rays detected by the first detection unit 211 of one of the first detection devices 21 exceeds a predetermined standard value, and in the case in which the amount of change in infrared rays exceeds the standard value, the generation unit 31a determines that a human being has entered the first predetermined region decided in advance. Additionally, in the case of determining that a human being has entered the first predetermined region, the generation unit 31a generates control information for switching on the first switch 16 of one of the image processing devices 10.

On the other hand, in the case in which the amount of change in infrared rays detected by the first detection unit 211 of one of the first detection devices 21 does not exceed the standard value, the generation unit 31a determines that a human being has not entered the first predetermined region, and does not generate the above-described control information for switching on the first switch 16 of one of the image processing devices 10.

The generation unit 31a may generate the control information as follows. Namely, the generation unit 31a references a lookup table defining a relationship between the amount of change in infrared rays detected by the first detection unit 211 of the first detection devices 21 and whether or not to switch on the first switch 16 of the image processing devices 10, for example, and computes whether or not to switch on the first switch 16 according to the received amount of change in infrared rays. After that, in the case in which the first switch 16 is to be switched on, the generation unit 31a generates control information for switching on the first switch 16.

Also, the generation unit 31a may use an artificial intelligence (AI) function to analyze the amount of change in infrared rays detected by the first detection unit 211 of the first detection devices 21 and determine whether or not to switch on the first switch 16.

The transmission unit 31b transmits the control information for switching on the first switch 16 generated by the generation unit 31a to the image processing device(s) 10 whose first switch 16 is to be switched on. The transmission unit 31b specifies the image processing device 10 of the IMEI stored in the storage unit 32 in association with the IMEI of the first detection device 21 that transmitted the detection result with which the generation unit 31a determined that a human being has entered the first predetermined region, and transmits the control information to the communication I/F 18 of the specified image processing device 10. The transmission unit 31b transmits the control information to the communication I/F 18 of the image processing device 10 over the network 5 by IP communication.

Note that a program executed by the CPU of the control unit 31 may be provided in a recorded state on a computer-readable recording medium, such as a magnetic recording medium (such as magnetic tape or a magnetic disk), an optical recording medium (such as an optical disc), a magneto-optical recording medium, or semiconductor memory. In addition, such a program may also be downloaded to the server device 30 by using a communication medium such as the Internet.

Also, the first control unit 212 of the first detection devices 21 rather than the generation unit 31a may determine whether or not a human being is present in the first predetermined region, and the generation unit 31a may generate control information on the basis of the determination result.

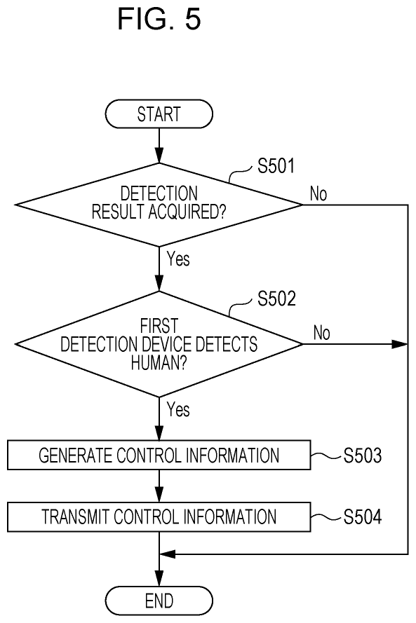

FIG. 5 is one example of a flowchart illustrating a control information transmission process performed by the server device 30.

The server device 30 determines whether or not a result of the detection by the first detection unit 211 has been received from one of the first detection devices 21 (S501). In the case of receiving a detection result (S501, Yes), the data is analyzed and it is determined whether or not the first detection device 21 has detected a human being entering the first predetermined region (S502). In the case in which the first detection device 21 has detected a human being (S502, Yes), control information for switching on the first switch 16 is generated (S503). These processes are performed by the generation unit 31a.

After that, the control information generated in S503 is transmitted to the image processing device 10 of the IMEI stored in association with the IMEI of the first detection device 21 that sent the data received in S501 (S504). This process is performed by the transmission unit 31b.

Otherwise, in the case in which data is not acquired from the first detection devices 21 (S501, No) and in the case in which a human being is not detected by the first detection devices 21 (S502, No), the process ends.

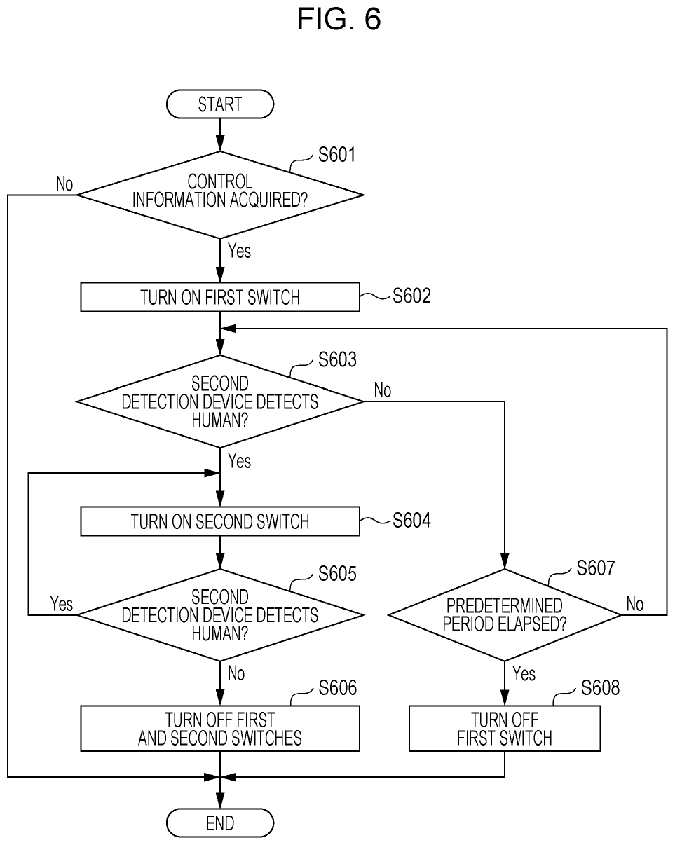

FIG. 6 is one example of a flowchart illustrating a switch opening-closing control process performed by the image processing device 10.

In the image processing device 10, it is determined whether or not the switch control unit 19 has acquired control information for switching on the first switch 16 from the server device 30 (S601).

In the case in which control information has been acquired (S601, Yes), the switch control unit 19 switches on the first switch 16 (S602). With this arrangement, power is supplied to the UI control unit 15, and in addition, power is supplied to the first detection device 21, the second detection device 22, and the operation panel 14.

After that, the UI control unit 15 determines whether or not the second detection device 22 has detected a human being (S603). In the case in which the second detection device 22 has detected a human being (S603, Yes), the UI control unit 15 switches on the second switch 17 (8604). After that, the UI control unit 15 determines whether or not the second detection device 22 has detected a human being (S605). While the second detection device 22 is detecting a human being (S605, Yes), the UI control unit 15 keeps the first switch 16 and the second switch 17 on. Otherwise, in the case in which the second detection device 22 no longer detects a human being (S605, No), the UI control unit 15 switches off the first switch 16 and the second switch 17 (S606), and ends the process.

On the other hand, in the process of S603, in the case of determining that the second detection device 22 has not detected a human being (S603, No), the UI control unit 15 determines whether or not a predetermined period decided in advance has elapsed (S607). In the case in which the predetermined period has not elapsed (S607, No), the processes from S603 are performed. Otherwise, in the case in which the predetermined period has elapsed (S607, Yes), the UI control unit 15 switches off the first switch 16 (S608), and ends the process.

As described above, in the system 1, each first detection device 21 transmits the detection result from the first detection unit 211 to the server device 30 through the LPWA 6 by non-IP communication. Additionally, in the case in which one of the first detection devices 21 detects that a human being has entered the first predetermined region, control information for switching on the first switch 16 of the image processing device 10 corresponding to the first detection device 21 is transmitted from the server device 30. Subsequently, according to the control information from the server device 30, the first switch 16 is switched on and power is supplied to the UI control unit 15, while in addition, power is supplied to the first detection device 21, the second detection device 22, and the operation panel 14. Additionally, the UI control unit 15 enters a state of acquiring a detection result from the second detection device 22. After that, in the case in which the second detection device 22 detects that a human being has entered the second predetermined region, the second switch 17 is switched on, and power is supplied to the image processing control unit 13.

According to the system 1 configured as above, power is supplied to the UI control unit 15 and the image processing control unit 13 after each image processing device 10 receives control information from the server device 30. Therefore, the power consumption of the image processing devices 10 is reduced compared to a configuration in which the image processing devices 10 continually receive detection results from the first detection devices 21 to ascertain whether or not a human being has entered the first predetermined region.

Also, even with a configuration in which detection results are periodically transmitted from the first detection devices 21 to the server device 30, because the detection results are sent by non-IP communication, the power consumption for transmitting detection results is reduced compared to a case of sending detection results by IP communication. In other words, the battery 215 of the first detection devices 21 lasts longer compared to the case of sending detection results by IP communication.

Also, because detection results are transmitted from the first detection devices 21 to the server device 30 through the LPWA 6, the server device 30 is capable of receiving detection results from the first detection devices 21 over a wide range. Therefore, it becomes possible to reduce the number of server devices 30 with respect to the range in which multiple image processing devices 10 are installed.

Note that in the exemplary embodiment described above, the first detection device 21 and the second detection device 22 are separate, but the first detection device 21 and the second detection device 22 may also be integrated. Hereinafter, this configuration will be referred to as an “integrated detection device”. An integrated detection device preferably includes the first detection unit 211 and the second detection unit 221, the first control unit 212 and the second control unit 222 (or a single control unit combining the two), the communication I/F 213, the communication I/F 223, the storage unit 214, and the battery 215. Additionally, the integrated detection device preferably is connected to the image processing device 10 by a single USB connection. In the integrated detection device configured in this way, the first control unit 212 transmits a detection result from the first detection unit 211 to the server device 30 through the LPWA 6 by non-IP communication. Additionally, in the case in which the first detection unit 211 detects that a human being has entered the first predetermined region, control information for switching on the first switch 16 of the image processing device 10 corresponding to the integrated detection device is transmitted from the server device 30. Subsequently, according to the control information from the server device 30, the first switch 16 is switched on and power is supplied to the UI control unit 15, while in addition, power is supplied to the integrated detection device and the operation panel 14. Additionally, the UI control unit 15 enters a state of acquiring a detection result from the second detection unit 221 of the integrated detection device. After that, in the case in which the second detection unit 221 detects that a human being has entered the second predetermined region, the second switch 17 is preferably switched on. In such a case, if a detection result is received from the first detection unit 211 of the integrated detection device through the LPWA 6 by non-IP communication, and it is ascertained that a human being has entered the first predetermined region, the generation unit 31a of the server device 30 preferably generates control information for controlling the integrated detection device such that a detection result from the second detection unit 221 of the integrated detection device is transmitted. Also, the transmission unit 31b of the server device 30 preferably transmits the control information generated by the generation unit 31a to the image processing device 10 stored in the storage unit 32 in association with the integrated detection device.

Next, a technique of storing, in the storage unit 32 of the server device 30, the IMEI of one of the first detection devices 21 in association with the IMEI of the image processing device 10 to which that first detection device 21 is connected will be described.

When one of the first detection devices 21 is connected to one of the image processing devices 10 by a connection such as USB, one control unit of either the first control unit 212 of the first detection device 21 or the switch control unit 19 of the image processing device 10 transmits, to the server device 30, association information for associating the IMEI as one example of identification information of the other control unit and the IMEI as one example of identification information of the transmitting control unit.

For example, in the case in which the first detection device 21 is connected to the image processing device 10, the switch control unit 19 of the image processing device 10 acquires the IMEI of the first control unit 212, or in other words, the IMEI of the first detection device 21, from the first control unit 212, and transmits this IMEI in association with the IMEI of the switch control unit 19 itself, or in other words, the IMEI of the image processing device 10. Note that when the first detection device 21 is connected to the image processing device 10, the switch control unit 19 of the image processing device 10 acquires the IMEI of the first detection device 21 acquired through the detection I/F 15b from the UI control unit 15.

Alternatively, in the case in which the first detection device 21 is connected to the image processing device 10, the first control unit 212 of the first detection device 21 acquires the IMEI of the switch control unit 19, or in other words, the IMEI of the image processing device 10, from the switch control unit 19 of the image processing device 10, and transmits this IMEI in association with the IMEI of the first control unit 212 itself, or in other words, the IMEI of the first detection device 21. Note that when the first detection device 21 is connected to the image processing device 10, the first control unit 212 of the first detection device 21 may acquire the IMEI of the image processing device 10 from the UI control unit 15 through the detection I/F 15b.

Note that multiple first detection devices 21 may also be connected to a single image processing device 10. Even if multiple first detection devices 21 are connected in this way, because the detection result are sent from the first detection devices 21 to the server device 30 by non-IP communication, the power consumption for transmitting detection results is small compared to the case of sending detection results by IP communication.

Also, in the exemplary embodiment described above, the detection results from the first detection devices 21 are sent by non-IP communication, but the detection results from the first detection devices 21 may also be sent by IP communication.

Also, the image processing devices 10 and the server device 30 may transmit and receive data through the LPWAs 6 by IP communication.

### Exemplary Modifications

The generation unit 31a according to an exemplary modification analyzes a history of the results of detection by the first detection unit 211 transmitted from the first detection devices 21, and generates control information for controlling the server device 30 according to the history analysis result.

Every time a result of detection by the first detection unit 211 is transmitted from one of the first detection devices 21, the generation unit 31a stores the detection result in the storage unit 32 in association with the IMEI of the first detection device 21. Subsequently, by analyzing the history of the results of detection by the first detection unit 211 stored in the storage unit 32, the generation unit 31a ascertains specific days of the week and specific times of day when the first detection devices 21 detect that a human being has entered the first predetermined region many times. For example, specific days of the week and specific times of day when the detection count per hour is equal to or greater than a predetermined count decided in advance (for example, 20 times) are ascertained. Subsequently, the generation unit 31a generates control information for keeping the first switch 16 of the image processing devices 10 switched on during the specific days of the week and specific times of day.

More specifically, in the case in which the per-hour detection count of detecting that a human being has entered the first predetermined region is a predetermined count or greater in the time period from 9:00 a.m. to 11:00 a.m. on Mondays, the generation unit 31a ascertains that the frequency is high from 9:00 a.m. to 11:00 a.m. on Mondays. Subsequently, the generation unit 31a generates control information for keeping the first switch 16 of the image processing devices 10 switched on during the time period from 9:00 a.m. to 11:00 a.m. on Mondays.

Note that the generation unit 31a may use an artificial intelligence (AI) function to analyze the history of the results of detection by the first detection unit 211 and ascertain specific days of the week and specific times of day when the first switch 16 of the image processing devices 10 is to be kept on.

Subsequently, the transmission unit 31b transmits the control information for keeping the first switch 16 switched on generated by the generation unit 31a to the image processing device(s) 10 whose first switch 16 is to be kept on. The transmission unit 31b specifies the image processing device 10 of the IMEI stored in the storage unit 32 in association with the IMEI of the first detection device 21 that transmitted the detection results analyzed by the generation unit 31a and determined to have a high frequency of a human being entering the first predetermined region during the specific days of the week and specific times of day, and transmits the control information to the specified image processing device 10.

In the image processing device 10 receiving the above control information, the first switch control unit 191 of the switch control unit 19 controls the first switch 16 to keep the first switch 16 switched on during the time period from 9:00 a.m. to 11:00 a.m. on Mondays.

In this way, the server device 30 uses a history of the results of detection by the first detection unit 211 transmitted from the first detection devices 21 to learn the time periods of a sleep state during which the image processing devices 10 switch off the first switch 16 and the second switch 17. Additionally, because the sleep state of the image processing devices 10 is decided according to the control information generated on the basis of learning by the server device 30, user convenience is improved.

### Second Exemplary Embodiment

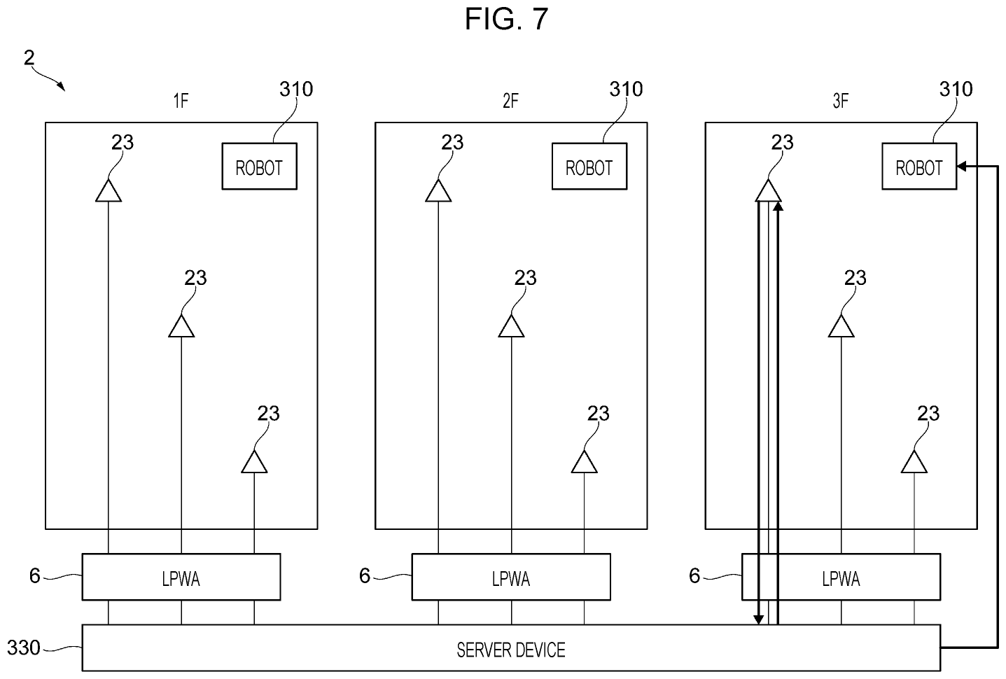

FIG. 7 is a diagram illustrating an example of a schematic configuration of a system 2 according to a second exemplary embodiment.

Hereinafter, the points regarding the system 2 according to the second exemplary embodiment that are different from the system 1 according to the first exemplary embodiment mainly will be described. Functions which are the same in the systems 1 and 2 will be denoted with the same signs, and a detailed description will be omitted.

The system 2 according to the second exemplary embodiment is provided with robots 310 as one example of a processing device, third detection devices 23, and a server device 330 that receives and analyzes data transmitted from the third detection devices 23, and transmits control information for controlling the robots 310 to the robots 310.

The system 2 exemplified in FIG. 7 illustrates an example of a system that guards the interior of a three-story building.

### [Configuration of Third Detection Devices 23]

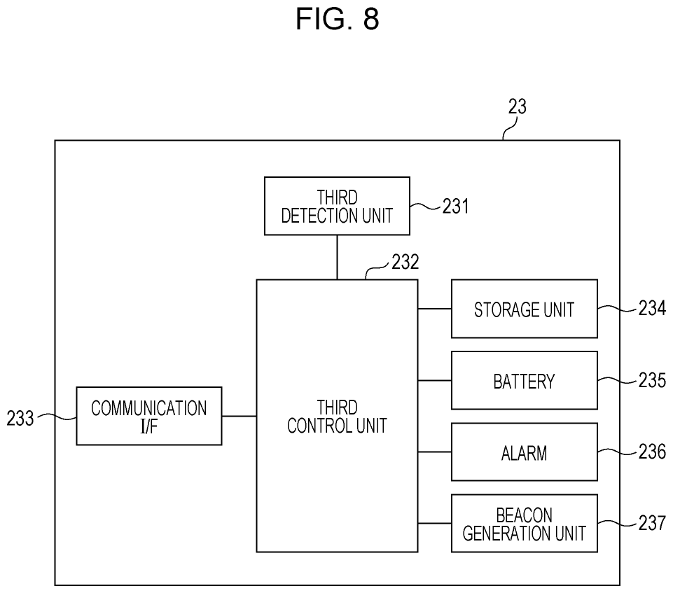

FIG. 8 is a diagram illustrating an example of a schematic configuration of one of the third detection devices 23.

The third detection device 23 includes a third detection unit 231 that acts as one example of a detector that detects a nearby event, and a third control unit 232 that acts as one example of a first controller that transmits data related to an event detected by the third detection unit 231 to the server device 330. Also, the third detection device 23 includes a communication I/F 233, a storage unit 234, a battery 235, an alarm 236 that emits sound, and a beacon generation unit 237 that generates a beacon.

The third detection unit 231 may be a monitoring camera that takes images of a monitoring region.

The third control unit 232 includes a CPU (not illustrated), RAM (not illustrated), and ROM (not illustrated). The third control unit 232 acquires an image taken by the third detection unit 231, and from the acquired image, detects whether or not an abnormality has occurred, such as the presence of an intruder for example. Subsequently, the third control unit 232 transmits the detection result of whether or not an abnormality has occurred to the server device 330 through the LPWA 6 periodically at a predetermined frequency. When transmitting the detection result, the third control unit 232 references information about the destination to which to send the detection result, namely the server device 330, stored in the storage unit 234. Also, in the case of detecting that an abnormality has occurred, the third control unit 232 causes a sound to be emitted from the alarm 236 and also causes the beacon generation unit 237 to generate a beacon.

Multiple third detection devices 23 are installed on each floor of the building (in FIG. 7, three per floor). Each third detection device 23 transmits the detection result to the server device 330 through the LPWA 6 by non-IP communication periodically at a predetermined frequency.

### [Configuration of Robots 310]

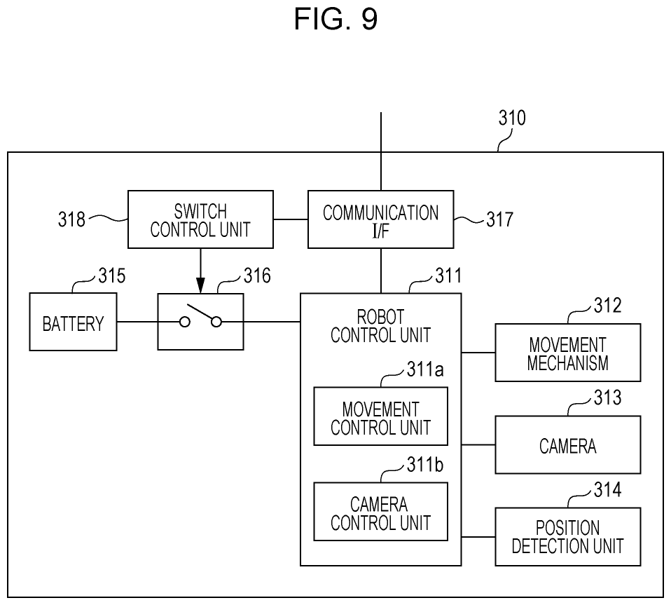

FIG. 9 is a diagram illustrating an example of a schematic configuration of one of the robots 310.

The robots 310 are devices capable of moving autonomously, and one each is deployed on each floor of the building. The external appearance of the robots 310 may be shaped to resemble a human being or an animal, for example. However, the resemblance is not limited to a human being or an animal, and the robots 310 may also be made to resemble a plant such as a flower or a tree, or a vehicle such as a car or an airplane.

Each robot 310 is provided with a robot control unit 311 that controls the overall motion of the robot 310, a movement mechanism 312 including wheels and the like that move the robot 310, a camera 313 that takes images of the surroundings of the robot 310, and a position detection unit 314 used to acquire position information. These units are interconnected by an internal bus. The camera 313 may be a device capable of taking images at a higher resolution than the third detection unit 231 of the third detection devices 23 for example.

Additionally, each robot 310 is provided with a battery 315 that supplies power to each unit and a switch 316 for switching the supply of power from the battery 315 to the robot control unit 311 on and off. Also, each robot 310 is provided with a communication I/F 317 and a switch control unit 318 that acts as one example of a second controller that controls the switching on and off of the switch 316 that acts as a processor, on the basis of data acquired through the communication I/F 317.

The communication I/F 317 may be a piece of equipment capable of transmitting and receiving data with the server device 330 and the third detection devices 23 according to a communication method such as Wi-Fi, Long Term Evolution (LTE), or Bluetooth (registered trademark). Note that the communication I/F 317 may also include a connector (not illustrated) for connecting a cable corresponding to the network 5 or the like.

The switch control unit 318 includes a CPU (not illustrated), RAM (not illustrated), and ROM (not illustrated). Also, in the case in which control information for performing a predetermined process described later is received from the server device 330 through the communication I/F 317, the switch control unit 318 switches on the switch 316 until the process ends. By switching on the switch 316, power is supplied to the robot control unit 311, the movement mechanism 312, the camera 313, and the position detection unit 314.

The robot control unit 311 includes a CPU (not illustrated), RAM (not illustrated), and ROM (not illustrated). Also, the robot control unit 311 includes a movement control unit 311a that controls the movement mechanism 312 to move the robot 310 to a location indicated by the server device 330. Also, the robot control unit 311 includes a camera control unit 311b that causes the camera 313 to take an image of the surroundings of the robot 310.

### [Configuration of Server Device 330]

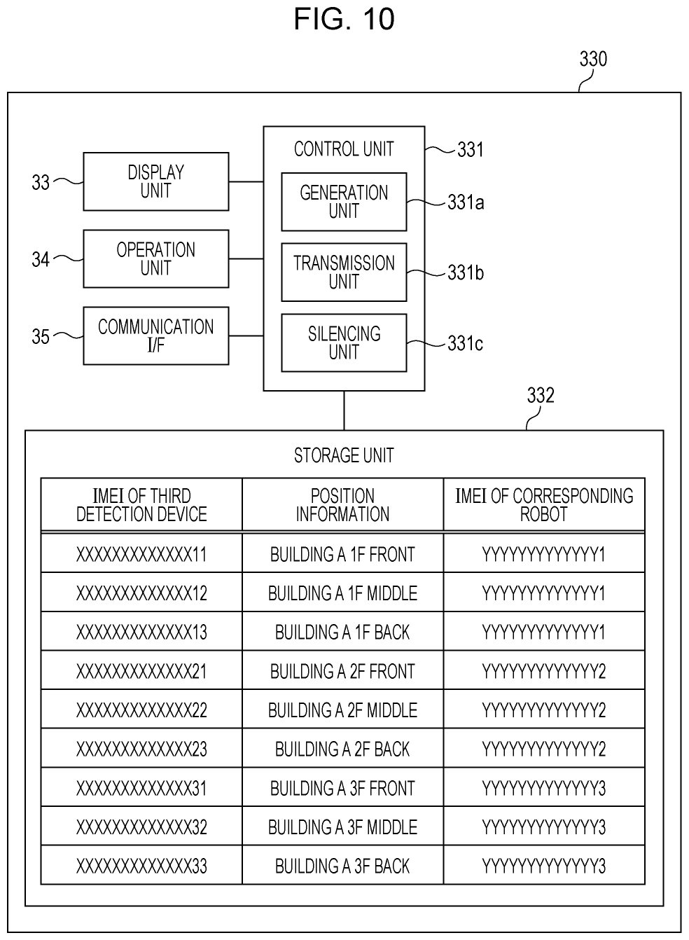

FIG. 10 is a diagram illustrating an example of a schematic configuration of the server device 330 according to the second exemplary embodiment.

The server device 330 is provided with a control unit 331 that controls the device overall, a storage unit 332 used to store data and the like, the display unit 33, the operation unit 34, and the communication I/F 35.

The storage unit 332 is a storage device such as an HDD or semiconductor memory, and stores, for each third detection device 23, position information about where the third detection device 23 is installed in association with the IMEI of the third detection device 23. Also, the storage unit 332 stores the IMEI of each third detection device 23 in association with the IMEI of the robot 310 deployed on the floor where the third detection device 23 is installed.

The control unit 331 includes a generation unit 331a that receives and analyzes detection results transmitted from the third control unit 232 of the third detection devices 23, and generates control information for controlling the robots 310. Also, the control unit 331 includes a transmission unit 331b that transmits the control information generated by the generation unit 331a to the robots 310. Additionally, the control unit 331 includes a silencing unit 331c that outputs, to the third detection devices 23, a reset signal silencing the sound of the alarm 236 emitted by the third detection devices 23.

In the case in which a detection result indicating that an abnormality has occurred is received from one of the third detection devices 23, the generation unit 331a generates control information for performing a predetermined process as follows to the robot 310 stored in association with the third detection device 23 that transmitted the detection result. The predetermined process may be the following process for example. Namely, move toward the position of the third detection device 23 that transmitted the detection result indicating that an abnormality has occurred until a beacon generated by the third detection device 23 is received. When the beacon is received, cause the camera 313 to take an image of the surroundings, and transmit information indicating receipt of the beacon together with the taken image to the server device 330.

The transmission unit 331b transmits control information generated by the generation unit 331a to the robot 310 designated as a recipient. The transmission unit 331b specifies the robot 310 of the IMEI stored in the storage unit 332 in association with the IMEI of the third detection device 23 that transmitted the detection result indicating that an abnormality has occurred, and transmits control information to the communication I/F 317 of the specified robot 310. The transmission unit 331b transmits the control information to the communication I/F 317 of the robot 310 by IP communication over Wi-Fi for example.

After information indicating receipt of the beacon is received from the robot 310, the silencing unit 331c outputs a reset signal for silencing the sound of the alarm 236 to the third detection device 23 that generated the beacon by non-IP communication through the LPWA 6.

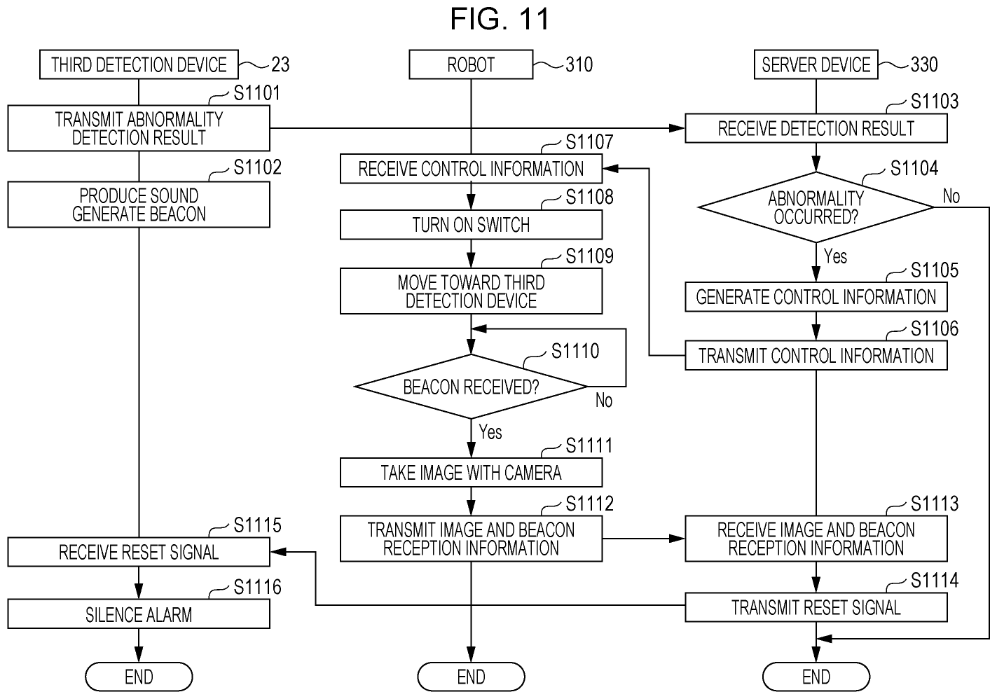

FIG. 11 is one example of a sequence diagram illustrating a processing sequence by the system 2 according to the second exemplary embodiment.

In the system 2 configured as above, each third detection device 23 periodically transmits a detection result to the server device 330 by non-IP communication. For example, in the case in which one of the third detection devices 23 detect that an abnormality has occurred, a detection result about the occurrence of the abnormality is transmitted to the server device 330 (S1101). Also, the third detection device 23 causes a sound to be emitted from the alarm 236 and also causes a beacon to be generated (S1102).

In the server device 330, the detection result transmitted from the third detection device 23 is received (S1103). Subsequently, it is determined whether or not an abnormality has occurred (S1104). Additionally, in the case in which the third detection device 23 has detected the occurrence of an abnormality (S1104, Yes), the server device 330 generates control information for performing the predetermined process described above to the robot 310 of the IMEI stored in association with the IMEI of the third detection device 23 that sent the data (S1105). Subsequently, the control information is transmitted to the robot 310 by IP communication (S1106).

In the robot 310, after the control information is received through the communication I/F 317 (S1107), the switch 316 is switched on (S1108). Subsequently, the robot 310 moves toward the third detection device 23 that transmitted the detection result indicating that an abnormality has occurred (S1109). Additionally, it is determined whether or not a beacon is received (S1110). In the case of receiving the beacon (S1110, Yes), an image of the surroundings is taken with the camera 313 (S1111), and information indicating receipt of the beacon together with the taken image are transmitted to the server device 330 (S1112).

In the server device 330, after the information indicating receipt of the beacon together with the taken image are received (S1113), a reset signal is transmitted to the third detection device 23 by non-IP communication (S1114). By analyzing the image taken by the camera 313 of the robot 310, the server device 330 becomes able to grasp the abnormal situation highly accurately.

Meanwhile, after receiving the reset signal (S1115), the third detection device 23 silences the sound of the alarm 236 (S1116).

According to the system 2 configured as above, when the one of the robots 310 receives control information from the server device 330, power is supplied to the robot control unit 311. Therefore, the power consumption of the robots 310 is reduced compared to a configuration in which the robots 310 continually receive detection results from the third detection devices 23 and ascertain whether or not an abnormality has occurred.

Also, even with a configuration in which detection results are transmitted from the third detection devices 23 to the server device 330, because the detection results are sent by non-IP communication, the power consumption for transmitting detection results is reduced compared to a case of sending detection results by IP communication.

Also, each robot 310 uses the camera 313 to take an image of higher resolution than the third detection unit 231 of the third detection device 23 and transmits the image to the server device 330 only in the case in which one of the third detection devices 23 detects the occurrence of an abnormality. Therefore, the power consumption of the robots 310 is reduced compared to a configuration in which the robots 310 continually take images with the camera 313 periodically and transmit the taken images to the server device 330. Also, because the server device 330 analyzes the high-resolution image taken by the camera 313 of one of the robots 310 only in the case in which one of the third detection devices 23 detects the occurrence of an abnormality, power consumption for image analysis is reduced.

Also, because each third detection device 23 transmits a detection result to the server device 330 through the LPWA 6, the server device 330 is capable of receiving the detection result from the third detection device 23 even if the third detection device 23 is set up in the back of the building. Therefore, it becomes possible to reduce the number of server devices 330 with respect to the range in which multiple third detection devices 23 are installed.

Also, because the third detection devices 23 are configured to transmit detection results to the server device 330 while the robots 310 are configured to receive control information from the server device 330, the third detection devices 23 and the robots 310 do not have to be associated directly.

Note that in the system 2 described above, one of the third detection devices 23 generates a beacon while one of the robots 310 receives the beacon and transmits an indication of receipt to the server device 330, but the configuration is not particularly limited thereto. One of the robots 310 may generate a beacon, and when one of the third detection devices 23 receives the beacon, the third detection device 23 may transmit an indication of receipt to the server device 330 through the LPWA 6.

Also, in the system 2 described above, the server device 330 transmits the reset signal for silencing the sound of the alarm 236 to the third detection devices 23 by non-IP communication, but the configuration is not particularly limited thereto. After receiving a beacon generated by one of the third detection devices 23 for example, one of the robots 310 may transmit a reset signal to the third detection device 23. In such a case, the control unit 331 of the robot 310 functions as one example of a second controller that controls the third detection device 23.

Also, in the system 2 described above, the robots 310 and the server device 330 are configured to transmit and receive data by a communication method such as Wi-Fi, Long Term Evolution (LTE), or Bluetooth (registered trademark), but the configuration is not particularly limited thereto. For example, the robots 310 and the server device 330 may transmit and receive data through the LPWAs 6 by IP communication.

### Third Exemplary Embodiment

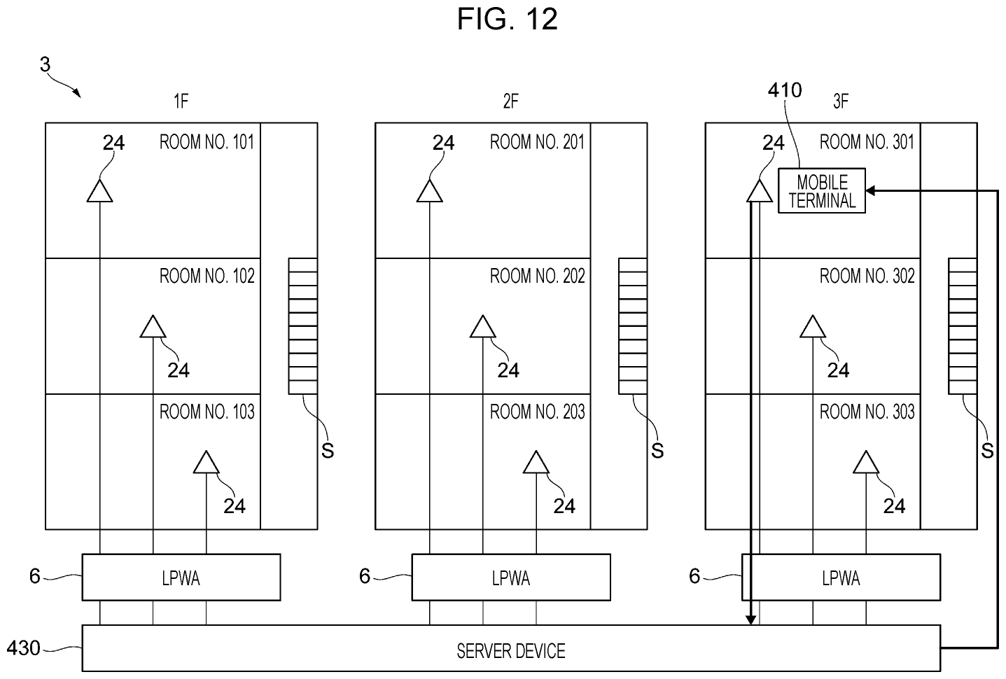

FIG. 12 is a diagram illustrating an example of a schematic configuration of a system 3 according to a third exemplary embodiment.

Hereinafter, the points regarding the system 3 according to the third exemplary embodiment that are different from the system 2 according to the second exemplary embodiment will be described. Functions which are the same in the systems 2 and 3 will be denoted with the same signs, and a detailed description will be omitted.

The system 3 is provided with a mobile terminal 410, fourth detection devices 24, and a server device 430 that receives and analyzes data transmitted from the fourth detection devices 24, and transmits control information for displaying the position of the mobile terminal 410 to the mobile terminal 410.

The system 3 exemplified in FIG. 12 illustrates an example of a system that displays information about a position inside a three-story building provided with a stairway S for example.

### [Configuration of Mobile Terminal 410]

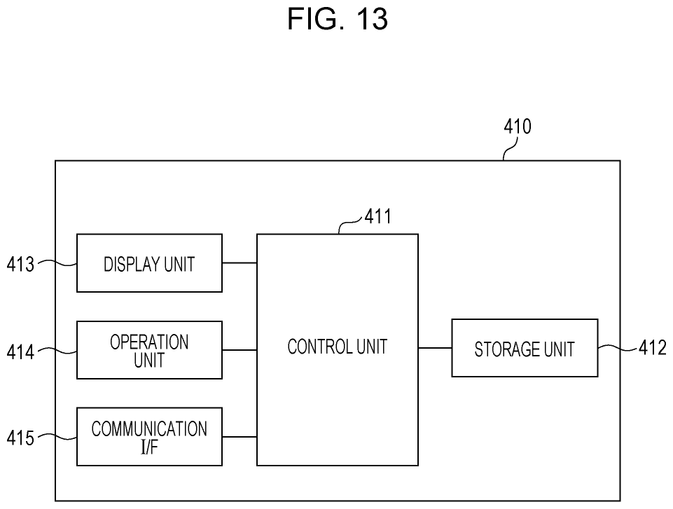

FIG. 13 is a diagram illustrating an example of a schematic configuration of the mobile terminal 410.

The mobile terminal 410 may be a multifunctional mobile phone (also known as a “smartphone”), a personal digital assistant (PDA), a tablet, a tablet PC, or a laptop PC provided with a short-range wireless communication function such as Bluetooth (registered trademark) for example.

The mobile terminal 410 is provided with a control unit 411 that controls the device overall, a storage unit 412 used to store data and the like, a display unit 413 used to display operation reception screens and images, an operation unit 414 that receives input operations from a user, and a communication I/F 415 used to communicate with other devices.

The storage unit 412 may be a storage device such as semiconductor memory. The storage unit 412 stores the IMEI of the mobile terminal 410. The storage unit 412 stores the International Mobile Subscriber Identity (hereinafter referred to as the “IMSI” in some cases) of the mobile terminal 410.

The display unit 413 is a display device that displays still images, moving images, and the like. The display unit 413 may be a liquid crystal display or an organic electroluminescence (EL) display, for example.

The operation unit 414 is an input device that receives operations from the user. The operation unit 414 may be a touch panel.

The communication I/F 415 may be a piece of equipment capable of transmitting and receiving data with the server device 430 and the fourth detection devices 24 according to a communication method such as Wi-Fi, Long Term Evolution (LTE), or Bluetooth (registered trademark).

The control unit 411 includes a CPU (not illustrated), RAM (not illustrated) used as working memory of the CPU and the like, and ROM (not illustrated) that stores various programs executed by the CPU and the like. Additionally, the control unit 411 controls the operations of the mobile terminal 410 overall by having the CPU load a program stored in the ROM into the RAM and execute the program.

### [Configuration of Fourth Detection Devices 24]

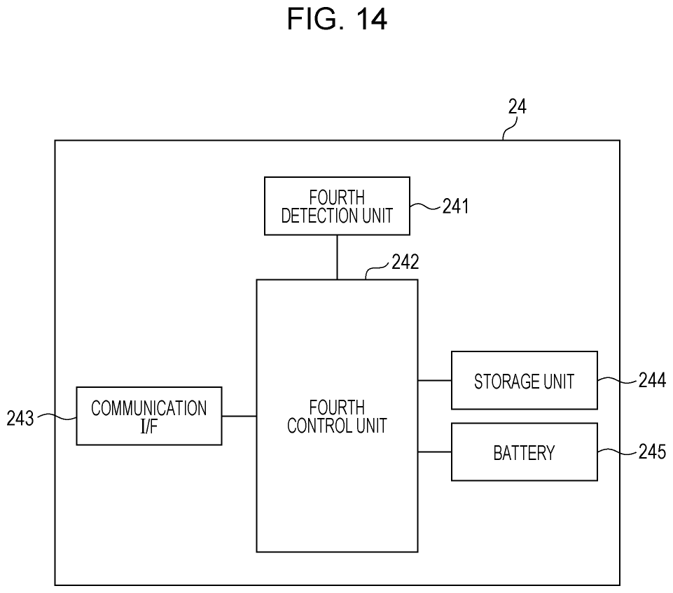

FIG. 14 is a diagram illustrating an example of a schematic configuration of one of the fourth detection devices 24.

Each fourth detection device 24 includes a fourth detection unit 241 that acts as one example of a detector that detects a nearby event, a fourth control unit 242 that acts as one example of a first controller that transmits data related to an event detected by the fourth detection unit 241 to the server device 430, a communication I/F 243, a storage unit 244, and a battery 245.

The fourth detection unit 241 detects Bluetooth (registered trademark) radio waves emitted by the mobile terminal 410.

In the case in which the fourth detection unit 241 detects Bluetooth (registered trademark) radio waves, the fourth control unit 242 ascertains mobile terminal identification information (hereinafter referred to as “identification information” in some cases) of the mobile terminal 410, and executes pairing with the mobile terminal 410. Subsequently, the fourth control unit 242 transmits the identification information of the paired mobile terminal 410 and the IMEI of the fourth detection device 24 to the server device 430 by non-IP communication. Note that the identification information may be the IMEI or the IMSI of the mobile terminal 410.

The communication I/F 243 has a function of enabling communication with the mobile terminal 410 over Bluetooth (registered trademark). Also, the communication I/F 243 has a function of enabling communication with the server device 430 over the LPWA 6.

The storage unit 244 is a storage device such as semiconductor memory, and stores the IMEI of the fourth detection device 24.

### [Configuration of Server Device 430]

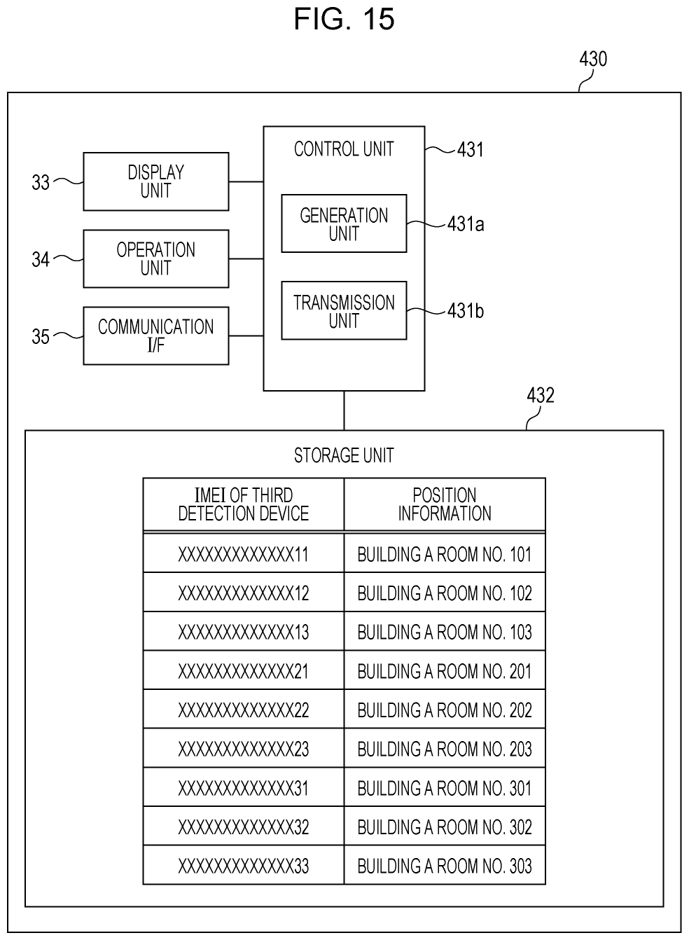

FIG. 15 is a diagram illustrating an example of a schematic configuration of the server device 430 according to the third exemplary embodiment.

The server device 430 is provided with a control unit 431 that controls the device overall, a storage unit 432 used to store data and the like, the display unit 33, the operation unit 34, and the communication I/F 35.

The storage unit 432 is a storage device such as an HDD or semiconductor memory, and stores map information about the building. Also, the storage unit 432 stores information about the positions in the building where the fourth detection devices 24 are installed, in association with the IMEIs of the fourth detection devices 24.

The control unit 431 includes a generation unit 431a that receives and analyzes data transmitted from the fourth control unit 242 of the fourth detection devices 24, and generates control information for displaying position information about the mobile terminal 410 on the display unit 413 of the mobile terminal 410. Also, the control unit 431 includes a transmission unit 431b that transmits the control information generated by the generation unit 431a to the mobile terminal 410.

In the case in which the IMEI of one of the fourth detection devices 24 and the identification information of the mobile terminal 410 are acquired from the fourth detection device 24, the generation unit 431a generates control information for displaying position information about the mobile terminal 410 on the display unit 413 of the mobile terminal 410 paired with the fourth detection device 24. In this case, the position information about the mobile terminal 410 displayed on the display unit 413 of the mobile terminal 410 is the range within which Bluetooth (registered trademark) radio waves emitted by the fourth detection device 24 paired with the mobile terminal 410 are detectable. For example, the position where the fourth detection device 24 paired with the mobile terminal 410 is installed may be displayed as the position information about the mobile terminal 410.

The transmission unit 431b transmits control information generated by the generation unit 431a to the mobile terminal 410 designated as a recipient. The transmission unit 431b specifies the mobile terminal 410 using the identification information of the mobile terminal 410 transmitted from the fourth detection device 24, and transmits the control information to the communication I/F 415 of the specified mobile terminal 410. The transmission unit 431b may transmit the control information to the communication I/F 415 of the mobile terminal 410 over a mobile communication network for example.

In this way, the system 3 is a system capable of using data transmitted from one of the fourth detection devices 24 installed inside the building to inform the mobile terminal 410 of position information about the mobile terminal 410 existing inside the building, and by extension, about the user carrying the mobile terminal 410.

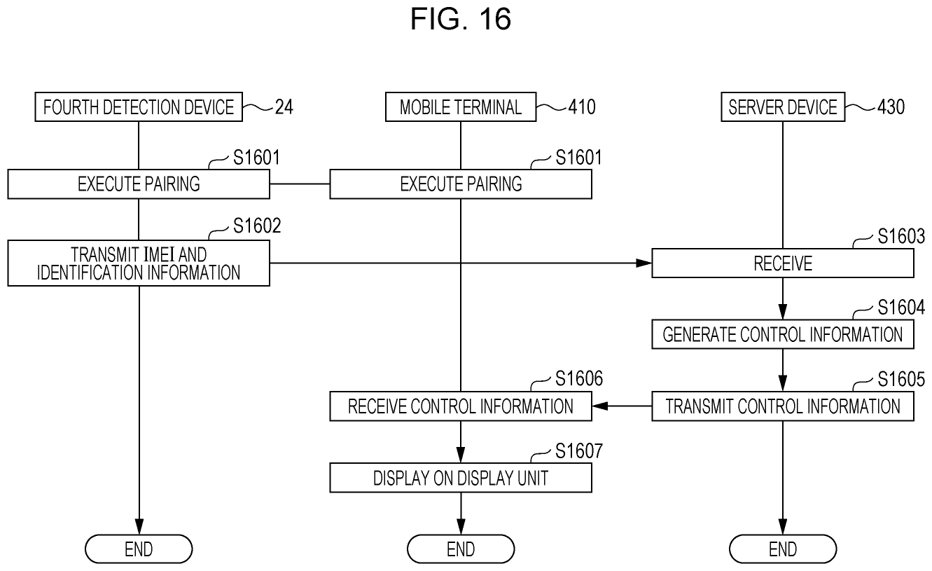

FIG. 16 is one example of a sequence diagram illustrating a processing sequence by the system 3 according to the third exemplary embodiment.

In the system 3 configured as above, in the case in which one of the fourth detection devices 24 detects Bluetooth (registered trademark) radio waves emitted by the mobile terminal 410, the fourth detection device 24 executes pairing with the mobile terminal 410 (S1601). Subsequently, the fourth detection device 24 transmits the identification information of the paired mobile terminal 410 and the IMEI of the fourth detection device 24 to the server device 430 by non-IP communication (S1602).

In the server device 430, the identification information of the mobile terminal 410 and the IMEI of the fourth detection device 24 transmitted from the fourth detection device 24 are received (S1603). Subsequently, the server device 430 generates control information for displaying position information about the mobile terminal 410 on the display unit 413 of the mobile terminal 410 whose identification information was transmitted (S1604). In addition, the server device 430 transmits the generated control information to the mobile terminal 410 paired with the fourth detection device 24 (S1605).

In the mobile terminal 410, after the control information is received (S1606), the position information is displayed on the display unit 413 (S1607). With this arrangement, position information about the user carrying the mobile terminal 410 is reported on the mobile terminal 410.

According to the system 3 configured as above, information indicating that one of the fourth detection devices 24 has paired with the mobile terminal 410 is transmitted to the server device 430 by non-IP communication. Therefore, the power consumption for transmitting a pairing result is reduced compared to the case of sending the pairing result by IP communication. Also, because the pairing result is transmitted through the LPWA 6, it becomes easier to extend the communicable range to every corner of the building compared to Wi-Fi for example. As a result, it becomes possible to specify position information about the user with higher precision. Therefore, the number of server devices 430 is reduced with respect to the area of the building in which the fourth detection devices 24 are installed.

Note that in the system 3 described above, the mobile terminal 410 and the server device 430 are configured to transmit and receive data by a communication method such as Wi-Fi, Long Term Evolution (LTE), or Bluetooth (registered trademark), but the configuration is not particularly limited thereto. For example, the mobile terminal 410 and the server device 430 may transmit and receive data through one of the LPWAs 6 by IP communication.

Also, the detection device or devices (for example, the first detection devices 21 according to the first exemplary embodiment) that transmit information to the server device (for example, the server device 30 according to the first exemplary embodiment) are not limited to a sensor that detects human beings, a monitoring camera, or Bluetooth (registered trademark) radio waves.

For example, a temperature sensor that detects body temperature or atmospheric temperature is also acceptable. The temperature sensor in a piece of clothing (for example, a work uniform) provided with the temperature sensor and a fan transmits a detection result to a server device by non-IP communication. Subsequently, the server devices may receive and analyze the temperature that is the detection result from the temperature sensor, and transmit control information for controlling the operation of the fan to the fan. With this arrangement, the power consumption of the fan is reduced compared to a configuration in which the fan continually receives and analyzes the detection result from the temperature sensor and controls the operation of the fan. Also, since it is not necessary to equip the fan with a control device for receiving and analyzing the detection result from the temperature sensor, a more lightweight fan may be attained.

Additionally, the detection device may also be a health care sensor that detects the heart rate or the like of a human being. The health care sensor in a multifunctional mobile phone having the built-in health care sensor transmits a detection result to a server device by non-IP communication. Subsequently, the server device receives and analyzes the heart rate or the like that is the detection result from the health care sensor, and in cases such as when additional information is demanded because the human being is at risk of a deteriorated physical condition according to the received detection result, the server device preferably transmits control information causing the multifunctional mobile phone to transmit additional information. With this arrangement, because it is sufficient for the multifunctional mobile phone to acquire and transmit demanded information only in cases where the human being is at risk of deteriorated physical condition, the power consumption of the multifunctional mobile phone is reduced compared to a configuration in which the multifunctional mobile phone continually receives and analyzes detection results from the health care sensor.

The processes performed by the server devices described above (for example, the server device 30 according to the first exemplary embodiment) may be achieved by the cooperative action of software and hardware resources. In this case, the CPU of the control unit (for example, the control unit 31 according to the first exemplary embodiment) executes a program that realizes each function of the control unit, and causes each function to be achieved. For example, a non-transitory computer-readable recording medium storing the program is provided to the control unit, and the CPU reads out the program stored in the recording medium. In this case, the program itself read out from the recording medium achieves the functions of the exemplary embodiments described above, and the program itself as well as the recording medium storing the program constitute an exemplary embodiment of the present disclosure. The recording medium for supplying such a program may be, for example, a flexible disk, a CD-ROM, a DVD-ROM, a hard disk, an optical disc, a magneto-optical disc, a CD-R, magnetic tape, a non-volatile memory card, or ROM. The program may also be downloaded to the server device over the network 5.

Additionally, a program constituting an exemplary embodiment of the present disclosure is a program causing a computer to execute: a function of receiving and analyzing data transmitted from a detection device (for example, one of the first detection devices 21) that detects a nearby event, and generating control information for controlling a processing device (for example, the image processing device 10 according to the first exemplary embodiment) that performs processing; and a function of transmitting the control information to the processing device associated with the detection device from which the data is transmitted. Note that “analyzing” may involve computing an output corresponding to an input by referencing a lookup table in which relationships between inputs and outputs corresponding to the inputs are defined in advance, analyzing by using an artificial intelligence (AI) function, and the like.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A system comprising:
a detection device including a detector that detects a nearby event and a first controller that transmits data related to an event detected by the detector to an external device;
a processing device including a processor that performs processing or a second controller that controls the detection device; and
an external device including
a generation unit that receives and analyzes the data transmitted from the first controller, and generates control information for controlling the processor or the detection device, and
a transmitter that transmits the control information to the second controller associated with the first controller from which the data is transmitted.

2. A system comprising:
a detection device including a detector that detects a nearby event and a first controller that transmits data related to an event detected by the detector to an external device;
a processing device including a processor that performs processing or a second controller that controls the detection device; and
an external device including
a generation unit that receives and analyzes the data transmitted from the first controller, and generates control information for controlling the processor or the detection device, and
a transmitter that transmits the control information to the second controller associated with the first controller from which the data is transmitted, wherein
the transmitter specifies the second controller associated with identification information of the first controller from which the data is transmitted, and transmits the control information to the specified second controller.

3. The system according to claim 1, wherein
one controller of either the first controller or the second controller transmits, to the external device, association information for associating identification information of the other controller with identification information of the controller itself.

4. The system according to claim 2, wherein
one controller of either the first controller or the second controller transmits, to the external device, association information for associating identification information of the other controller with identification information of the controller itself.

5. The system according to claim 3, wherein
in a case in which the detection device is connected to the processing device, the second controller acquires identification information of the first controller from the first controller and transmits the association information.

6. The system according to claim 4, wherein
in a case in which the detection device is connected to the processing device, the second controller acquires identification information of the first controller from the first controller and transmits the association information.

7. The system according to claim 3, wherein
in a case in which the detection device is connected to the processing device, the first controller acquires identification information of the second controller from the second controller and transmits the association information.

8. The system according to claim 4, wherein
in a case in which the detection device is connected to the processing device, the first controller acquires identification information of the second controller from the second controller and transmits the association information.

9. The system according to claim 1, wherein
the second controller controls the processor or the detection device on a basis of the control information acquired from the external device.

10. The system according to claim 2, wherein
the second controller controls the processor or the detection device on a basis of the control information acquired from the external device.

11. The system according to claim 3, wherein
the second controller controls the processor or the detection device on a basis of the control information acquired from the external device.

12. The system according to claim 4, wherein
the second controller controls the processor or the detection device on a basis of the control information acquired from the external device.

13. The system according to claim 1, wherein
the first controller transmits the data to the external device in a state in which an amount of power supplied to the second controller is limited.

14. The system according to claim 2, wherein
the first controller transmits the data to the external device in a state in which an amount of power supplied to the second controller is limited.

15. The system according to claim 3, wherein
the first controller transmits the data to the external device in a state in which an amount of power supplied to the second controller is limited.

16. The system according to claim 4, wherein
the first controller transmits the data to the external device in a state in which an amount of power supplied to the second controller is limited.

17. The system according to claim 13, wherein
the limitation is removed after the second controller receives the control information transmitted from the transmitter.

18. The system according to claim 14, wherein
the limitation is removed after the second controller receives the control information transmitted from the transmitter.

19. A non-transitory computer readable medium storing a program causing a computer to execute a process for processing information, the process comprising:
receiving and analyzing data transmitted from a detection device that detects a nearby event, and generating control information for controlling a processing device that performs processing or the detection device; and
transmitting the control information to the processing device associated with the detection device from which the data is transmitted.
